(19) United States
(12) Patent Application Publication
(10) Pub. No.: US 2019/0288500 A1
(43) Pub. Date: Sep. 19, 2019

(54) ARC DETECTING APPARATUS AND CONTROL METHOD THEREOF, NON-TRANSITORY COMPUTER READABLE RECORDING MEDIUM, AND DC POWER SYSTEM

(71) Applicant: OMRON Corporation, Kyoto (JP)

(72) Inventors: Kohei TOMITA, Kyoto-shi (JP); Satoru IKEMOTO, Kyoto-shi (JP); Naoki MAKI, Kyoto-shi (JP); Takayuki KUROKI, Kyoto-shi (JP)

(73) Assignee: OMRON Corporation, KYOTO (JP)

(21) Appl. No.: 16/249,912

(22) Filed: Jan. 17, 2019

(30) Foreign Application Priority Data
Mar. 14, 2018 (JP) 2018-047193

(51) Int. Cl. H02H 1/00; H02S 40/32; H02H 3/32; H02S 50/10

(52) U.S. Cl. CPC H02H 1/0015; H02S 50/10; H02H 3/32; H02S 40/32

(57) ABSTRACT

In the disclosure, the occurrence of an arc is rapidly detected while the frequency of erroneous detection is suppressed. An arc detecting apparatus includes an arc presence/absence determining part determining presence or absence of an arc based on an AC current from a solar cell, and a repeat number setting part setting, based on the DC current from the solar cell, a repeat number of processing that the arc presence/absence determining part repeatedly performs to determine the presence or absence of the arc.

### CROSS-REFERENCE TO RELATED APPLICATION

This application claims the priority of Japan patent application serial no. 2018-047193, filed on Mar. 14, 2018. The entirety of the above-mentioned patent application is hereby incorporated by reference herein and made a part of this specification.

### BACKGROUND

### Technical Field

The disclosure relates to an arc detecting apparatus applied to a DC power system, such as a solar power system, a control method thereof, a control program, and a DC power system.

### Description of Related Art

Conventionally, in a solar power system, the power generated by a solar cell is supplied to a power transmission network via a power conditioning system (hereinafter simply referred to as PCS) including a DC/AC converter, etc. In such a solar power system, an arc may be generated due to a failure of a circuit, etc., in the system. In the case where an arc is generated, the temperature at the portion where the arc is generated becomes high, and there is a risk of causing a fire, etc. Therefore, the solar power system includes an arc detecting apparatus that detects the occurrence of an arc by measuring the AC current of the arc with a current sensor.

In the arc detecting apparatus described in Patent Document 1 (Japanese Laid-Open No. 2016-151514), firstly, the output current of a solar cell string is detected by a current sensor, and the detected output current is converted into a power spectrum. Next, with respect to the power spectrum of a measuring interval of the arc, which is a predetermined frequency range, the measuring interval is divided into a plurality of domains, and any of the domain values, which are the magnitudes of the power spectrum of the respective domains, excluding the maximum domain value is acquired to serve as the interval value of the measuring interval. Then, the interval value is compared with a threshold to determine the presence or absence of an arc.

As described above, when an arc occurs, there is a risk of causing a fire, etc., so it is desired to quickly detect the occurrence of the arc. In order to quickly detect the occurrence of the arc, for example, it is conceivable to lower the threshold.

However, in this case, the frequency that the noise other than the arc (for example, the switching noise of the PCS, etc.) is erroneously determined as the noise of the arc, and the occurrence of the arc is erroneously detected is increased. The solar power system needs to be temporarily shut down for every detection or erroneous detection of the occurrence of the arc. Therefore, with the increased frequency of erroneous detection, the power generation efficiency decreases.

One aspect of the disclosure provides an arc detecting apparatus, etc., that is capable of quickly detecting the occurrence of the arc while suppressing the frequency of erroneous detection.

### SUMMARY

An arc detecting apparatus according to one aspect of the disclosure includes an arc determining part which determines presence or absence of an arc based on an AC current from a DC power source that generates power or charges and discharges power, and a repeat number setting part which sets, based on a DC current from the DC power source, a repeat number of processing that the arc determining part repeatedly performs to determine the presence or absence of the arc.

Further, another aspect of the disclosure provides a control method of an arc detecting apparatus. The control method includes: an arc determining step of determining presence or absence of an arc based on an AC current from a DC power source that generates power or charges and discharges power; and a repeat number setting step of setting a repeat number of processing repeatedly performed to determine the presence or absence of the arc in the arc determination step based on a DC current from the DC power source.

It should be noted that the same effect as described above can be achieved in a DC power system including a DC power source which generates power or charges or discharges power and the arc detecting apparatus having the above configuration.

An arc detecting apparatus according to one aspect of the disclosure may be realized by a computer; in this case, a control program of the arc detecting apparatus which causes the computer to realize the arc detecting apparatus by causing the computer to operate as each part included in the arc detecting apparatus, and a computer readable recording medium on which the control program is recorded are also within the scope of this disclosure.

### BRIEF DESCRIPTION OF THE DRAWINGS

FIG. 1 is a schematic circuit diagram showing an example of a configuration of a solar power system including an arc detecting apparatus according to an embodiment of the disclosure.

FIG. 2 is a block diagram showing an example of a configuration of the arc detecting apparatus.

FIG. 3(a) is a graph showing a time waveform of a current signal detected by a current sensor in the arc departing apparatus, and FIG. 3(b) is a graph showing a waveform of a power spectrum of a current signal generated by a CPU in the arc detecting apparatus.

FIG. 4 is a flowchart showing an example of the operation of the arc detecting apparatus.

FIG. 5 is a schematic circuit diagram showing a modified example of the solar power system.

FIG. 6 is a flowchart showing another example of the operation of the arc detecting apparatus.

FIG. 7 is a flowchart showing another example of the operation of the arc detecting apparatus.

FIG. 8 is a block diagram showing an example of the configuration of a PCS in a solar power system according to another embodiment of the disclosure.

FIG. 9 is a block diagram showing an example of a configuration of an optimizer and an arc detecting apparatus provided in each solar cell module in a solar power system according to still another embodiment of the disclosure.

FIG. 10 is a block diagram showing an example of a configuration of an optimizer and an arc detecting apparatus provided in a solar power system according to another embodiment of the disclosure.

### DESCRIPTION OF THE EMBODIMENTS

Hereinafter, embodiments according to one aspect of the disclosure (hereinafter also referred to as “this embodiment”) will be described with reference to the drawings.

### § 1 Application Example

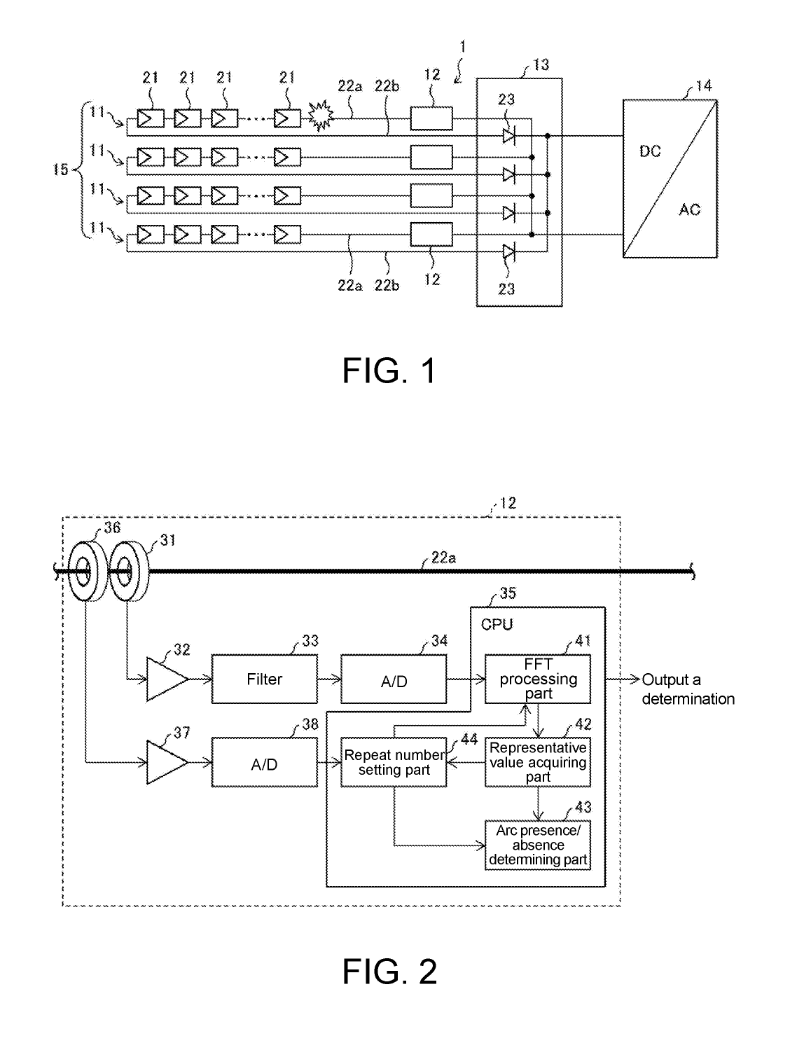

First, an example of a scenario to which the disclosure is applied will be described with reference to FIGS. 1 and 2.

FIG. 1 is a schematic circuit diagram showing an example of the configuration of a solar power system including an arc detecting apparatus according to this embodiment. As shown in FIG. 1, a solar power system 1 (DC power system) includes a plurality of solar cell strings 11 (DC power source), an arc detecting apparatus 12, a junction box 13, and a power conditioning system (hereinafter referred to as PCS) 14.

FIG. 2 is a block diagram showing an example of the configuration of the arc detecting apparatus 12. As shown in FIG. 2, the arc detecting apparatus 12 includes an AC current sensor 31 (current measuring part), an amplifier 32, a filter 33, an A/D converting part 34, a central processing unit (CPU) 35, a DC current sensor 36 (current measuring part) and an A/D converting part 38.

As shown in FIG. 1 and FIG. 2, the arc detecting apparatus 12 includes the AC current sensor 31 for measuring an AC current from the solar cell string 11, an arc presence/absence determining part (arc determining part) 43 for determining the presence or absence of an arc based on the AC current measured by the AC current sensor 31, a DC current sensor 36 for measuring a DC current from the solar cell string 11, and a repeat number setting part 44 for setting, based on the DC current measured by the DC current sensor 36, the repeat number of the processing that the arc presence/absence determining part 43 repeatedly performs to determine the presence or absence of the arc.

According to this configuration, based on the DC current, the repeat number of the processing repeatedly performed to determine the presence or absence of the arc is set. For example, as the DC current increases, the repeat number may be decreased. When the DC current is high, the signal strength of the AC current is increased, and the possibility of erroneously determining noise other than the arc as the noise of the arc is decreased. On the other hand, when the repeat number decreases, the possibility of erroneous determination increases, but the occurrence of the arc can be detected quickly. Therefore, the occurrence of the arc can be quickly detected while the possibility of erroneous determination can be suppressed. That is, the occurrence of the arc can be quickly detected while the frequency of erroneously detecting the occurrence of the arc can be suppressed.

Also, if the DC current is high, since the energy of the arc is strong, the risk of a fire, etc., due to the arc increases. Therefore, by using the arc detecting apparatus of this embodiment, the risk can be effectively reduced, and as a result, the solar power system 1 can be used safely.

As the DC current decreases, the repeat number may be increased. If the DC current decreases, the signal strength of the AC current is decreased, and the possibility that noise other than the arc is erroneously determined as the noise of the arc is increased. On the other hand, as the repeat number increases, even though the detection of the occurrence of the arc is delayed, the possibility of erroneous determination is decreased. Therefore, the possibility of erroneous determination can be suppressed, and the frequency of erroneously detecting the occurrence of the arc can be suppressed.

### § 2 Configuration Example

Embodiments of the disclosure will be described with reference to FIGS. 1 to 7. For the convenience of description, the members shown in the respective embodiments and the members sharing the same functions therewith are denoted by the same reference numerals, and the description thereof is omitted as appropriate.

(Outline of Solar Power System)

As shown in FIG. 1, the solar cell string 11 (DC power source) is formed by connecting a plurality of solar cell modules 21 in series. Each solar cell module 21 includes a plurality of solar cells (not shown) connected in series, and is formed in a panel shape. The solar cell strings 11 constitute a solar cell array 15 (DC power source). Each solar cell string 11 is connected to the PCS 14 via the junction box 13.

The PCS 14 converts DC power input from each solar cell string 11 into AC power and outputs the AC power. In place of the PCS 14, a load apparatus that consumes the DC power may be provided.

The junction box 13 connects the solar cell strings 11 in parallel. In particular, output lines 22a connected to terminals of the respective solar cell strings 11 are connected to each other and output lines 22b connected to the other terminals of the respective solar cell strings 11 are connected to each other. It should be noted that a reverse flow preventing diode 23 is provided at the output line 22b.

In this embodiment, the arc detecting apparatus 12 is provided at the output line 22a of the solar cell string 11 for each solar cell string 11.

(Arc Detecting Apparatus 12)

As shown in FIG. 2, the AC current sensor 31 detects the AC current flowing through the output line 22a. The AC current sensor 31 is configured to include a current transformer (CT), for example. The amplifier 32 amplifies the AC current signal detected by the AC current sensor 31.

The filter 33 is a band pass filter (BPF), and allows only an AC current signal in a predetermined frequency range, among the AC current signals output from the amplifier 32, to pass through. In this embodiment, the frequency range that the filter 33 allows to pass through is 40 kHz to 100 kHz. In this way, the AC current signal of a frequency component (usually 40 kHz or less) including a large amount of switching noise of a converter (DC/DC converter) that the PCS 14 includes can be excluded from the AC current signals output from the amplifier 32.

The A/D converting part 34 converts the analog AC current signal passing through the filter 33 into a digital AC current signal and inputs the digital AC current signal to the CPU 35.

The CPU 35 performs FFT on the digital AC current signal input from the A/D converting part 34, and generates a power spectrum of the AC current signal. Further, the CPU 35 determines the presence or absence of occurrence of the arc based on the generated power spectrum. Then, the CPU 35 outputs the determination result to the outside.

This determination result is input to a control apparatus (not shown) of the solar power system 1, for example. When the determination result that the arc is present is input from the CPU 35, the control apparatus cuts off the circuit of the solar power system 1 to prevent a fire due to the arc or the damage of the solar power system 1.

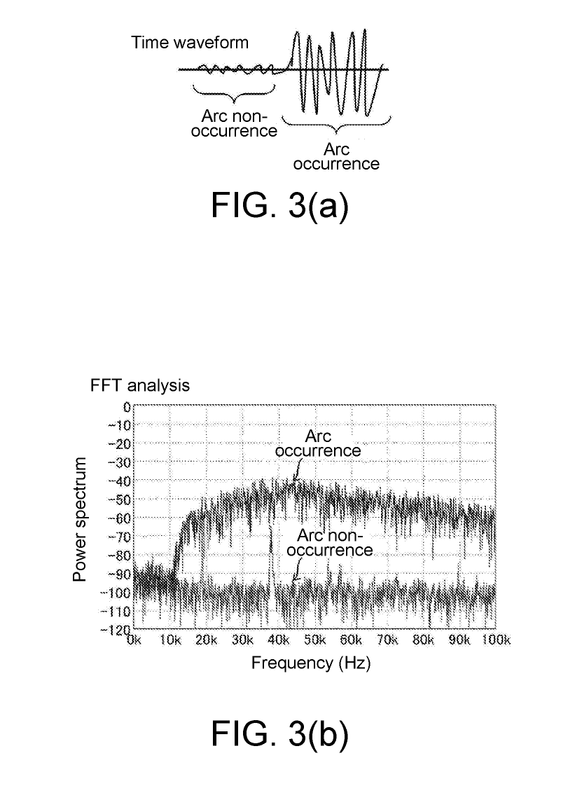

FIG. 3(a) is a graph showing a time waveform of the AC current signal detected by the AC current sensor 31, and FIG. 3(b) is a graph showing a waveform of the power spectrum of the AC current signal generated by the CPU 35. In FIGS. 3(a) and 3(b), the waveforms in both arc occurrence and arc non-occurrence states are shown.

In the case where the arc does not occur in the solar cell string 11, the waveform of the AC current signal is formed as the waveform of the arc non-occurrence state as shown in FIG. 3(a), and the waveform of the power spectrum of the AC current signal is formed as the waveform of the arc non-occurrence state as shown in FIG. 3(b). On the other hand, in the case where the arc occurs in the solar cell string 11, the waveform of the AC current signal is formed as the waveform of the arc occurrence state as shown in FIG. 3(a), and the waveform of the power spectrum of the AC current signal is formed as the waveform of the arc occurrence state as shown in FIG. 3(b).

Referring to FIGS. 3(a) and 3(b), it can be understood that, compared with the arc non-occurrence state, the amplitude of the AC current signal increases and the level of the power spectrum of the AC current signal increases in the arc occurrence state. Therefore, based on the high frequency component of the AC current signal detected by the AC current sensor 31, the arc detecting apparatus 12 can detect the occurrence of the arc in the solar cell string 11.

As shown in FIG. 2, the DC current sensor 36 detects the DC current flowing through the output line 22a. The DC current sensor 36 is configured to include, for example, a DC current transformer (DCCT). The amplifier 37 amplifies the DC current signal detected by the DC current sensor 36. The A/D converting part 38 converts the analog DC current signal output from the amplifier 37 into the digital DC current value and inputs the digital DC current value to the CPU 35.

(CPU 35)

As shown in FIG. 2, the CPU 35 has an FFT processing part 41, a representative value acquiring part 42, the arc presence/absence determining part 43 and the repeat number setting part 44.

The FFT processing part 41 captures the digital current signal input from the A/D converting part 34, repeats the capturing multiple times, performs FFT processing on the captured current signal set, so as to generate the power spectrum of the current signal. The FFT processing part 41 provides the generated power spectrum of the current signals to the representative value acquiring part 42.

The representative value acquiring part 42 acquires the representative value of the power spectrum of the current signal based on the power spectrum of the current signal from the FFT processing part 41. The representative value acquiring part 42 provides the acquired representative value to the arc presence/absence determining part 43 and the repeat number setting part 44.

As the representative value, various types can be considered. For example, the representative value may be a statistical value, such as an average value, a maximum value, a minimum value, a median value, a mode value, etc., of the power spectrum at the predetermined measuring interval (for example, 40 kHz to 80 kHz). In addition, the representative value may be a value obtained by integrating the power spectrum over the measuring interval.

Further, as described in Patent Document 1, with respect to the power spectrum of the measuring interval of the arc, the measuring interval is divided into a plurality of domains, and any of the domain values, which are the magnitudes of the power spectrum of the respective domains, excluding the maximum domain value may be acquired as the interval value of the measuring interval, and the acquired interval value may be the representative value. Also, in addition to acquiring the interval value of the measuring interval of the arc, the interval value with respect to the power spectrum of the measuring interval of the noise in a frequency range different from the measuring interval of the arc may be acquired, and the ratio or the difference between the interval value of the measuring interval of the arc and the interval value of the measuring interval of the noise may serve as the representative value.

The arc presence/absence determining part 43 uses a representative value S acquired by the representative value acquiring part 42 to determine the presence or absence of the arc. The arc presence/absence determining part 43 outputs the determination result to the outside.

Specifically, the arc presence/absence determining part 43 compares the representative value S acquired by the representative value acquiring part 42 with a predetermined threshold K, and determines whether the representative value S is greater than the threshold K. As a result of this determination, the arc presence/absence determining part 43 makes a temporary determination that the arc is present if the representative value S is greater than the threshold K, and makes a temporary determination that the arc is absent if the representative value S is less than or equal to the threshold K.

It should be noted that the threshold K can be easily determined by repeatedly performing the operation of determining the presence or absence of the arc. That is, excessive trial-and-errors are unnecessary for determining the threshold K.

The FFT processing part 41, the representative value acquiring part 42 and the arc presence/absence determining part 43 repeat the processing (temporary determination processing) for a plurality of times, and in the case where the number of times of the temporary determination process is within a certain number of times, if the determination result that the arc is present exceeds a certain number of times, the arc presence/absence determining part 43 outputs a final determination result that the arc is present to the outside.

This final determination result is input to a control apparatus (not shown) of the solar power system 1, for example. With the final determination result that the arc is present being from the arc presence/absence determining part 43, the control apparatus cuts off the circuit of the solar power system 1, so as to prevent a fire due to the arc or the damage of the solar power system 1.

Based on the DC current value from the A/D converting part 38, the repeat number setting part 44 sets the repeat number in the repeated processing performed in the FFT processing part 41 or the arc presence/absence determining part 43. The repeat number setting part 44 provides the set repeat number to the FFT processing part 41 or the arc presence/absence determining part 43.

As a result, for example, the FFT processing part 41 repeats capturing of data for the number of times of the repeat number set by the repeat number setting part 44. Alternatively, the arc presence/absence determining part 43 repeats the temporary determination processing for the number of times of the repeat number. Alternatively, the arc presence/absence determining part 43 outputs the final determination result that the arc is present to the outside when the temporary determination result that the arc is present repeats the number of times of the repeat number.

(Operation of Arc Detecting Apparatus 12)

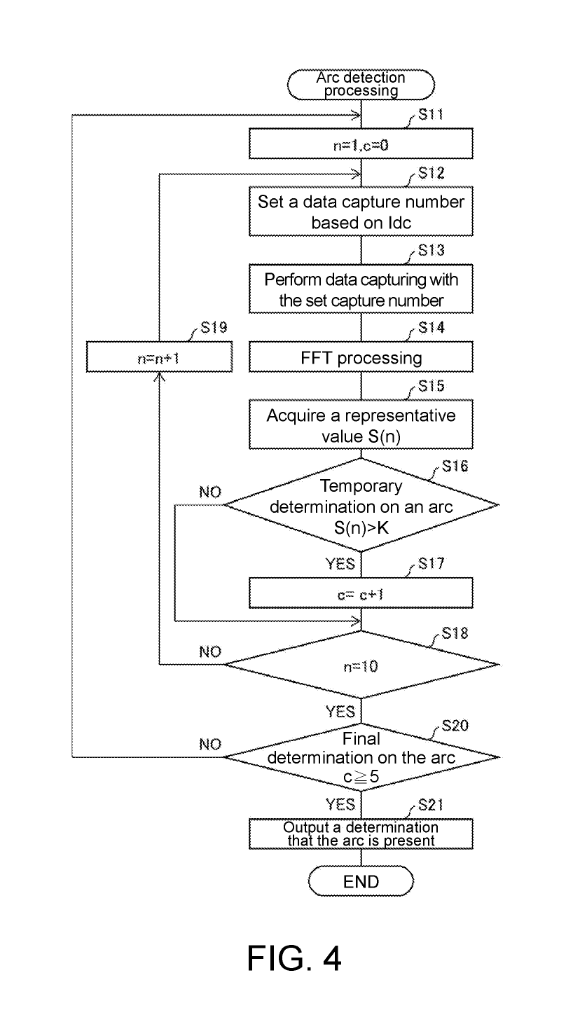

FIG. 4 is a flowchart showing an example of the operation of the arc detecting apparatus 12 having the above configuration. In FIG. 4, the FFT processing part 41 repeatedly captures data for the number of times of the repeat number set by the repeat number setting part 44.

First, as shown in FIG. 4, in arc detection, the arc presence/absence determining part 43 respectively resets a counter n to an initial value 1 and a counter c to an initial value 0 (S11). Incidentally, the counter n is a counter for counting the number of times of determination of the arc, and the counter c is a counter for counting the number of times that the arc is determined as present in the arc determination result.

Next, the repeat number setting part 44 sets a capture number Ndata of data based on a DC current value Idc detected by the DC current sensor 36 and A/D-converted by the A/D converting part 38 (S12). For example, in the case where the DC current value Idc is less than 1 A, the capture number Ndata is set to be 8192. Further, in the case where the DC current value Idc is equal to or more than 1 A and less than 3 A, the capture number Ndata is set to be 4096. Further, in the case where the DC current value Idc is equal to or more than 3 A and less than 10 A, the capture number Ndata is set to be 2048. Further, in the case where the DC current value Idc is equal to or more than 10 A, the capture number Ndata is set to be 1024.

Next, the FFT processing part 41 captures the capture number Ndata, which is determined by the repeat number setting part 44, of data of the current signal that is detected by the AC current sensor 31, passes through the filter 33, and A/D converted by the AD-converting part 34 (S13). The FFT processing part 41 performs FFT processing on the captured data (S14), and generates the power spectrum of the current signal.

Next, the representative value acquiring part 42 acquires a representative value S(n) of the power spectrum of the current signal in the predetermined measuring interval in which the FFT processing part 41 performs the FFT (S15).

Next, the arc presence/absence determining part 43 compares the representative value S(n) acquired by the representative value acquiring part 42 with the predetermined threshold K (S16). In the case where the representative value S(n) is greater than the threshold K, the arc is determined as present, and 1 is added to the counter c (S17), and the flow proceeds to S18. On the other hand, in the determination of S16, in the case where the representative value S(n) is less than or equal to the threshold K, the arc is determined as absent. In this case, 1 is not added to the counter c, and the flow proceeds to S18.

In S18, whether the value of the counter n reaches 10, that is, whether n=10, is determined. If n is not 10, 1 is added to the counter n (S19), and the flow returns to S12 to repeat the above processes.

On the other hand, in S18, if n=10, whether the value of the counter c as the number of times that the arc is present is equal to or more than 5 is determined (S20). If the value of the counter c is less than 5, the flow returns to S11 to repeat the above operations.

Further, in S20, if the value of the counter c is equal to or more than 5, the final determination result that the arc is present (arc occurrence) is output (S21). Then, the arc detection processing ends. As described above, in this embodiment, the arc presence/absence determining part 43 outputs the final determination result that the arc is present in the case where there are five times or more of the determination result that the arc is present out of 10 times of the determination on the presence or absence of the arc.

Then, upon receiving the final determination result that the arc is present from the arc presence/absence determining part 43, in order to prevent a fire caused by the arc or the damage of the solar power system 1, the control apparatus of the solar power system 1 cuts off the circuit of solar power system 1.

### Modified Example 1

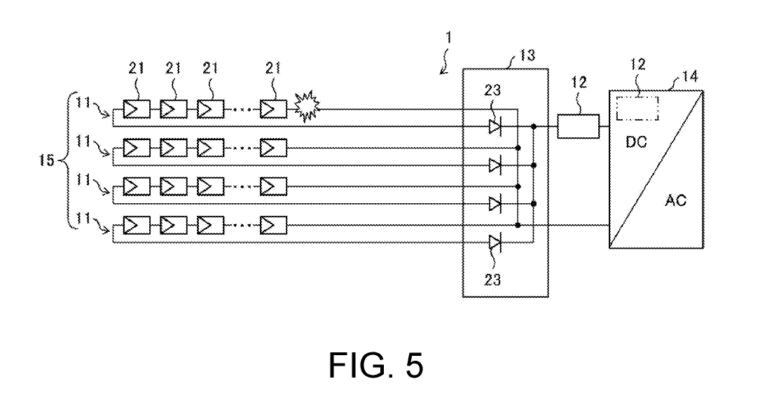

FIG. 5 is a schematic circuit diagram showing a modified example of the solar power system 1 shown in FIG. 1. In the above embodiment, an example in which the arc detecting apparatus 12 is individually provided for each solar cell string 11 is shown. However, the configuration of the arc detecting apparatus 12 is not limited thereto. That is, as shown in FIG. 5, it may also be that only one arc detecting apparatus 12 is provided in the solar power system 1 having the solar cell strings 11. In the example of FIG. 5, the arc detecting apparatus 12 is provided at a later stage of the junction box 13, that is, between the junction box 13 and the PCS 14.

Further, as shown in FIG. 5, the arc detecting apparatus 12 may be provided inside the housing of the PCS 14, instead of being provided between the junction box 13 and the PCS 14. This configuration will be described in another embodiment.

### Modified Example 2

In the case where the CPU 35 includes an A/D input part having the same function as the A/D converting part 34, 38, the A/D converting part 34, 38 can be omitted. In this case, the AC current signal from the filter 33 and the DC current signal from the amplifier 37 may be directly input to the A/D input part of the CPU 35.

### Modified Example 3

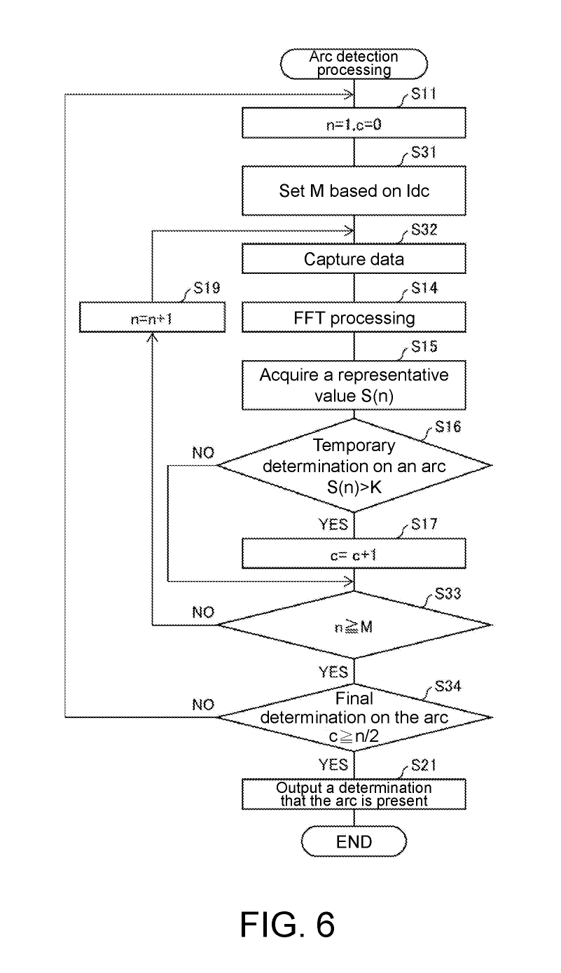

FIG. 6 is a flowchart showing another example of the operation of the arc detecting apparatus 12. In FIG. 6, the arc presence/absence determining part 43 repeats the temporary determination process for the number of times of the repeat number set by the repeat number setting part 44. In FIG. 6, the same step number S is added to the operations same as the operations shown in FIG. 4, and the descriptions of these operations are omitted.

First, as shown in FIG. 6, in the arc detection, the arc presence/absence determining part 43 resets the counter n to the initial value 1 and the counter c to the initial value 0 (S11).

Next, the repeat number setting part 44 sets a repeat number M of the temporary determination process based on the DC current value Idc detected by the DC current sensor 36 and A/D-converted by the A/D converting part 38 (S31). For example, in the case where the DC current value Idc is less than 1 A, the repeat number M is set to be 100. In the case where the DC current value Idc is equal to or more than 1 A and less than 3 A, the repeat number M is set to be 50. In the case where the DC current value Idc is equal to or more than 3 A and less than 10 A, the repeat number M is set to be 30. If the DC current value Idc is equal to or more than 10 A, the repeat number M is set to be 10.

Next, the FFT processing part 41 captures the predetermined capture number (for example, 1024) of the data of the current signal detected by the AC current sensor 31, passing through the filter 33, and A/D-converted by the A/D converting part 34 (S32). The FFT processing part 41 performs FFT processing on the captured data (S14), and generates the power spectrum of the current signal. Next, the representative value acquiring part 42 acquires the representative value S(n) of the power spectrum of the current signal in the predetermined measuring interval in which the FFT processing part 41 performs the FFT (S15).

Next, the arc presence/absence determining part 43 compares the representative value S(n) acquired by the representative value acquiring part 42 with the predetermined threshold K (S16). In the case where the representative value S(n) is greater than the threshold K, the arc is determined as present, and 1 is added to the counter c (S17), and the flow proceeds to S33. On the other hand, in the determination of S16, in the case where the representative value S(n) is less than or equal to the threshold K, the arc is determined as absent. In this case, 1 is not added to the counter c, and the flow proceeds to S33.

In S33, whether the value of the counter n reaches the repeat number M, that is, whether n≥M is determined. If it is not that n≥M, 1 is added to the counter n (S19), and the flow returns to S32 to repeat the above processes.

On the other hand, in S33, if n≥M, whether the value of the counter c as the number of times that the arc is present is equal to or more than n/2 is determined (S34). If the value of the counter c is less than n/2, the flow returns to S31 to repeat the above processes.

In addition in S34, if the value of the counter c is equal to or more than n/2, the final determination result that the arc is present is output (S21). Then, the arc detection processing ends. Thus, in this modified example, the arc presence/absence determining part 43 is adapted to output the final determination result that the arc is present in the case where there are n/2 times or more of the determination result that the arc is present out of n times of the temporary determination on the presence/absence of the arc.

### Modified Example 4

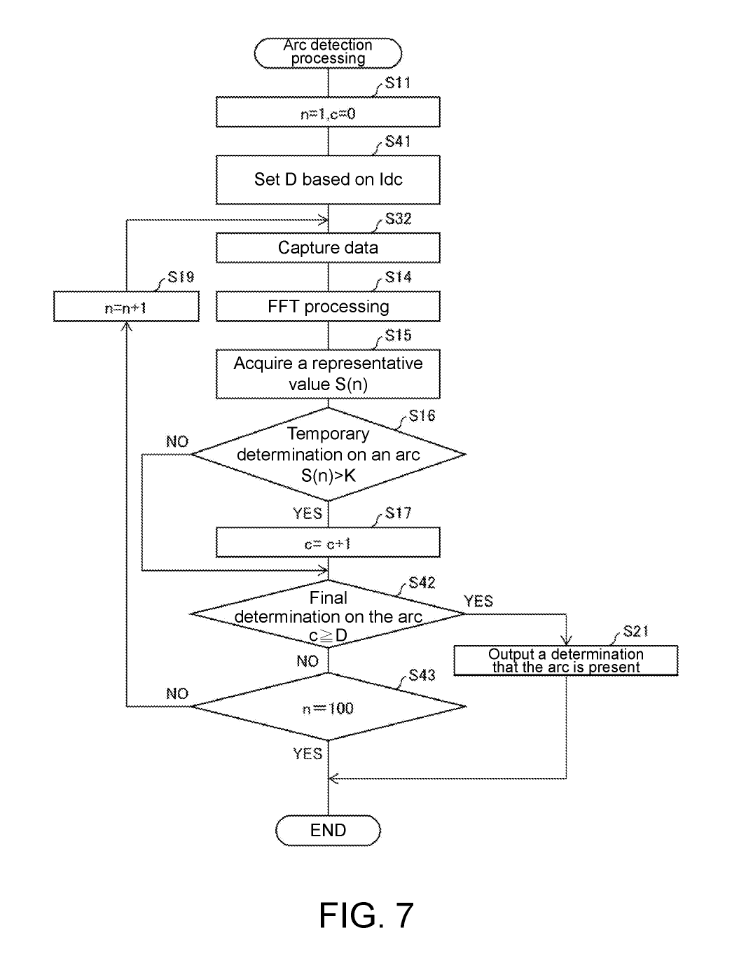

FIG. 7 is a flowchart showing another example of the operation of the arc detecting apparatus 12. In FIG. 7, the arc presence/absence determining part 43 outputs the final determination result that the arc is present to the outside in the case where the temporary determination result that the arc is present repeats the number of times of the repeat number set by the repeat number setting part 44. In FIG. 7, the same step number S is added to the operations same as the operations shown in FIGS. 4 and 6, and the descriptions of these operations are omitted.

First, as shown in FIG. 7, in the arc detection, the arc presence/absence determining part 43 resets the counter n to the initial value 1 and the counter c to the initial value 0 (S11).

Next, the repeat number setting part 44 sets, based on the DC current value Idc detected by the DC current sensor 36 and A/D-converted by the A/D converting part 38, a repeat number D of the temporary determination result that the arc is present (S41). For example, in the case where the DC current value Idc is less than 1 A, the repeat number D is set to be 50. In the case where the DC current value Idc is equal to or more than 1 A and less than 3 A, the repeat number D is set to be 25. Also, in the case where the DC current value Idc is equal to or more than 3 A and less than 10 A, the repeat number D is set to be 10. Also, in the case where the DC current value Idc is equal to or more than 10 A, the repeat number D is set to be 5.

Next, the FFT processing part 41 captures the predetermined capture number of the data of the current signal detected by the AC current sensor 31, passing through the filter 33, and A/D-converted by the A/D converting part 34 (S32). The FFT processing part 41 performs FFT processing on the captured data (S14), and generates the power spectrum of the current signal. Next, the representative value acquiring part 42 acquires the representative value S(n) of the power spectrum of the current signal in the predetermined measuring interval in which the FFT processing part 41 performs FFT (S15).

Next, the arc presence/absence determining part 43 compares the representative value S(n) acquired by the representative value acquiring part 42 with the predetermined threshold K (S16). In the case where the representative value S(n) is greater than the threshold K, the arc is determined as present, and 1 is added to the counter c (S17), and the flow proceeds to S42. On the other hand, in the determination of S16, in the case where the representative value S(n) is less than or equal to the threshold K, the arc is determined as absent. In this case, 1 is not added to the counter c, and the flow proceeds to S42.

In S42, whether the value of the counter c reaches the repeat number D, that is, whether c≥D is determined. If c≥D, the flow proceeds to S43. On the other hand, in S42, if c≥D, the final determination result that the arc is present is output (S21). Then, the arc detection processing ends.

In S43, whether the value of the counter n reaches 100, that is, whether n=100 is determined. If n is not 100, 1 is added to the counter n (S19), and the flow returns to S32 to repeat the above processes.

On the other hand, in S43, if n=100, the final determination that the arc is absent is made, and the arc detection processing ends. Thus, in this modified example, the arc presence/absence determining part 43 outputs the final determination result that the arc is present in the case where the temporary determination result that the arc is present exceeds the repeat number D.

### Embodiment 2

Another embodiment of the disclosure will be described below with reference to the drawings. In this embodiment, the solar power system 1 has a built-in arc detecting apparatus in the PCS 14 (converter apparatus).

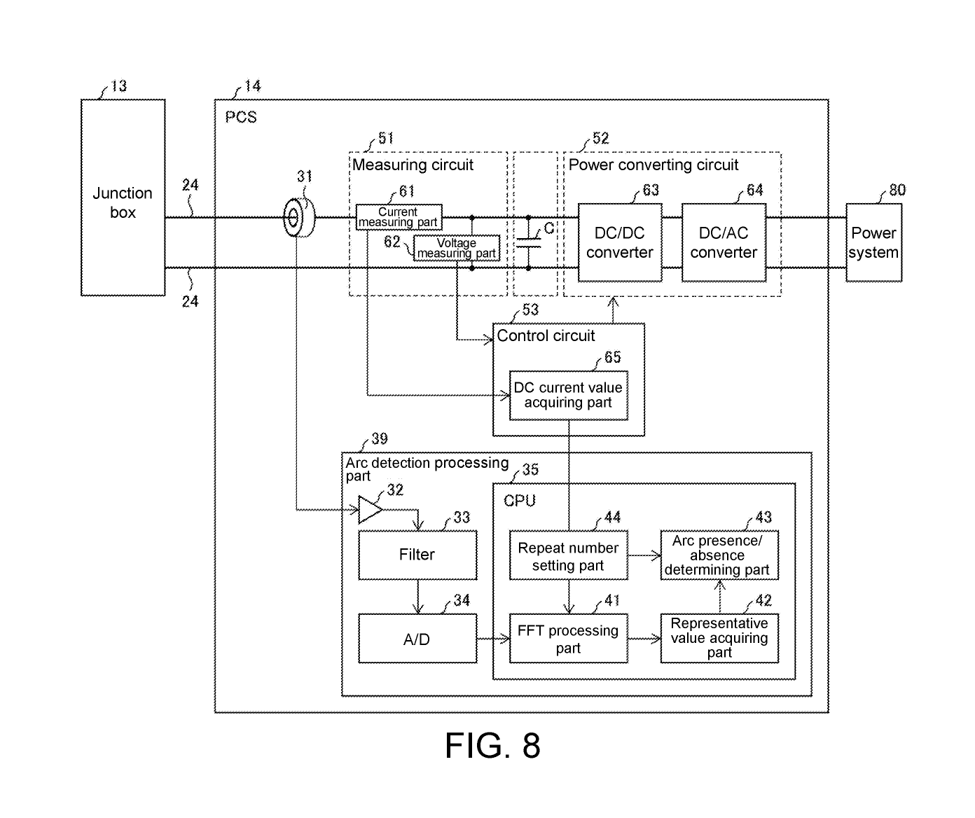

(Configuration of PCS 14) FIG. 8 is a block diagram showing an example of the configuration of the PCS 14 according to this embodiment. As shown in FIG. 8, the PCS 14 includes a measuring circuit 51, a power converting circuit 52, a control circuit 53 (control part), and a capacitor C.

The measuring circuit 51 has a current measuring part 61 and a voltage measuring part 62. The current measuring part 61 measures a current I flowing through a circuit 24. In addition, the voltage measuring part 62 measures a voltage V (voltage before conversion) between the circuits 24. The measurement results of the current I and the voltage V measured by the measuring circuit 51 are provided to the control circuit 53.

Further, the power converting circuit 52 is connected to the measuring circuit 51 via the capacitor C. By providing the capacitor C, the input of a surge voltage to the power converting circuit 52 can be prevented.

The power converting circuit 52 includes a DC/DC converter 63 (converting part) and a DC/AC converter 64. The DC/DC converter 63 is a circuit that converts (DC/DC conversion) the voltage of DC power and is, for example, a step-up chopper. As an example, the DC/DC converter 63 converts (boosts) the voltage of the DC power generated by the solar cell array 15 to a higher voltage. Then, the DC power whose voltage is converted by the DC/DC converter 63 is supplied to the DC/AC converter 64.

The DC/AC converter 64 is a circuit that converts (DC/AC conversion) the DC power supplied from the DC/DC converter 63 into AC power and is, for example, an inverter. As an example, the DC/AC converter 64 converts DC power into AC power with a frequency of 60 Hz. Then, the AC power converted by the DC/AC converter 64 is supplied to a power system 80.

The control circuit 53 generally controls the operation of the PCS 14. Specifically, the control circuit 53 controls the operation of the power converting circuit 52 based on the measurement results of the current I and the voltage V from the measuring circuit 51. As a result, the DC power generated by the solar cell array 15 can be converted into AC power having a predetermined voltage and frequency that enables system interconnection with the power system 80.

The control circuit 53 also has a DC current value acquiring part 65. The details of the DC current value acquiring part 65 will be described later.

In this embodiment, as shown in FIG. 8, the PCS 14 includes the AC current sensor 31, the amplifier 32, the filter 33, the A/D converting part 34, and the CPU 35 in the configuration of the arc detecting apparatus 12 shown in FIG. 2. Also, the PCS 14 uses the current measuring part 61 and the DC current value acquiring part 65 of the control circuit 53, instead of the DC current sensor 36, the amplifier 37 and the A/D converting part 38 in the arc detecting apparatus 12 shown in FIG. 2. In the following description, the configuration including the amplifier 32, the filter 33, the A/D converting part 34, and the CPU 35 will be referred to as an “arc detection processing part 39”.

The DC current value acquiring part 65 acquires a DC current value which is the value of the DC component among the current I measured by the current measuring part 61. The DC current value acquiring part 65 inputs the acquired DC current value to the repeat number setting part 44 of the CPU 35. Thus, like the arc detecting apparatus 12 shown in FIG. 2, the occurrence of the arc can be quickly detected while the frequency of erroneous detection can be suppressed.

### Modified Example 1

Meanwhile, the measuring part 61 built in the PCS 14 can normally measure not only the DC component of the current I but also the AC component. Therefore, the current measuring part 61 may be used in place of the AC current sensor 31. In this case, the AC component of the current I measured by the current measuring part 61 may also be input to the amplifier 32. In this way, by using a current sensor capable of measuring both DC current and AC current, the number of current sensors can be reduced from two to one. An example of the current sensor that can measure both DC and AC currents is a current sensor combining a CT and a Hall element.

### Modified Example 2

It should be noted that the measuring circuit 51 may be provided at the output side of the DC/DC converter 63. In this case, the control circuit 53 may control the DC/DC converter 63 based on the measurement results of the current and voltage output from the DC/DC converter 63. In addition, the repeat number setting part 44 may set the repeat number based on the DC current value of the current output from the solar cell array 15 via the junction box 13 and the DC/DC converter 63.

### Modified Example 3

It should be noted that the measuring circuit 51 may be added to the output side of the DC/DC converter 63. In this case, the control circuit 53 may control the DC/DC converter 63 based on the measurement results of the current and voltage input to the PCS 14 and the measurement results of the current and voltage output from the DC/DC converter 63. Also, the repeat number setting part 44 may set the repeat number based on at least one of the DC current value of the current output from the solar cell array 15 via the junction box 13 and the DC current value of the current output from the solar cell array 15 via the junction box 13 and the DC/DC converter 63.

### Third Embodiment

Still another embodiment of the disclosure will be described below with reference to the drawings. In the solar power system 1 of this embodiment, in order to more efficiently convert solar energy into electric power, an optimizer that optimizes the electric power having gone thus far with the PCS 14 by using the solar cell module 21 as a unit is adopted.

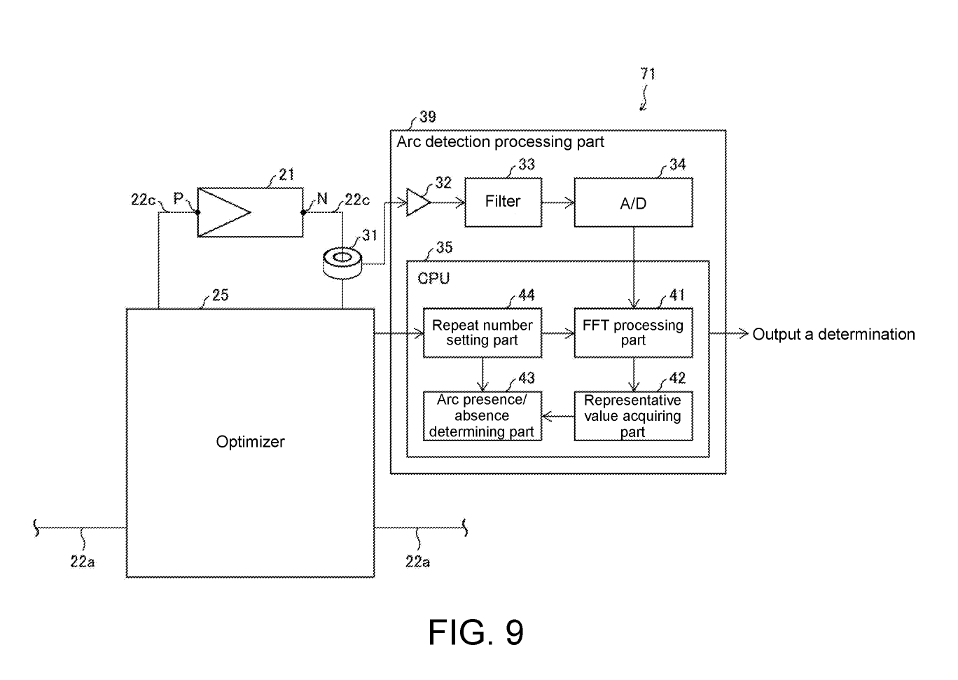

FIG. 9 is a block diagram showing an example of the configuration of an optimizer 25 (converter apparatus) and an arc detecting apparatus 71 provided in each solar cell module 21 (DC power source).

The optimizer 25 optimizes the power from the solar cell module 21 and supplies the output power to the output line 22a of the solar cell string 11. Accordingly, the power output efficiency from the solar cell string 11 to the PCS 14 can be improved.

The arc detecting apparatus 71 detects an arc in the solar cell module 21 and a circuit 22c between the solar cell module 21 and the optimizer 25. Like FIG. 8, the arc detecting apparatus 71 includes the AC current sensor 31 and the arc detection processing part 39. The AC current sensor 31 is provided in the circuit 22c.

The optimizer 25 has the same configuration as the current measuring part 61, the voltage measuring part 62 and the DC/DC converter 63 in the PCS 14. Therefore, the optimizer 25 measures the current from the solar cell module 21, and acquires the DC current value which is the DC component of the current.

Therefore, in this embodiment, the optimizer 25 inputs the acquired DC current value to the repeat number setting part 44 of the CPU 35. Thus, similar to the arc detecting apparatus 12 shown in FIG. 2, the occurrence of the arc can be quickly detected while the frequency of erroneous detection can be suppressed. Like the PCS 14 shown in FIG. 8, the arc detecting apparatus 71 may be built in the optimizer 25.

### Embodiment 4

Another embodiment of the disclosure will be described below with reference to the drawings. In the solar power system 1 of this embodiment, in order to more efficiently convert solar energy into electric power, an optimizer that optimizes the electric power having gone thus far with the PCS 14 by using the solar cell string 11 as a unit is adopted.

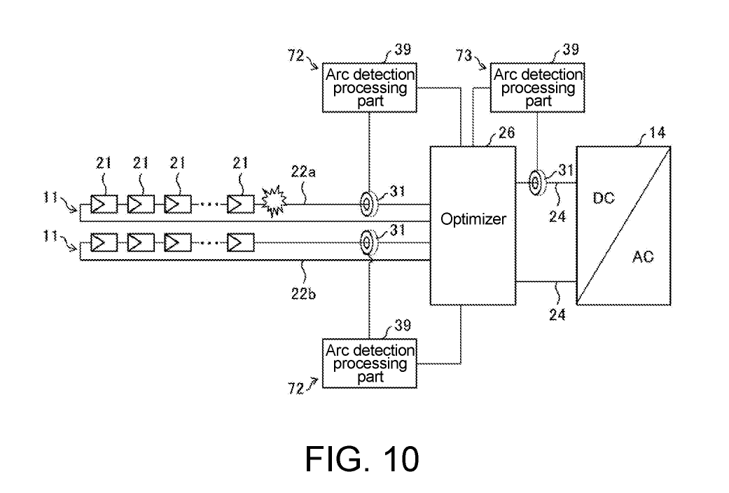

FIG. 10 is a block diagram showing an example of the configuration of an optimizer 26 (converter apparatus) and arc detecting apparatuses 72 and 73 provided in the solar power system 1 of this embodiment.

The optimizer 26 respectively optimizes the power from the solar cell strings 11, and supplies the output power to the PCS 14. Accordingly, the power output efficiency from the solar cell strings 11 to the PCS 14 can be improved.

The arc detecting apparatuses 72 respectively detect the arc in the solar cell strings 11. The arc detecting apparatus 72, like FIG. 8, includes the AC current sensor 31 and the arc detection processing part 39. The AC current sensor 31 of the arc detecting apparatus 72 is provided at the output line 22a.

The optimizer 26 has the same configuration as the current measuring part 61, the voltage measuring part 62 and the DC/DC converter 63 in the PCS 14. Therefore, the optimizer 26 measures the current from each solar cell string 11 and acquires the DC current value which is the DC component of the current.

Therefore, in this embodiment, the optimizer 26 inputs the DC current value of each solar cell string 11 to the arc detection processing part 39 of each arc detecting apparatus 72. As a result, like the arc detecting apparatus 71 shown in FIG. 9, the occurrence of the arc in each solar cell string 11 can be quickly detected while the frequency of erroneous detection can be suppressed.

On the other hand, the arc detecting apparatus 73 detects the arc in the circuit 24 between the optimizer 26 and the PCS 14. Like FIG. 8, the arc detecting apparatus 73 includes the AC current sensor 31 and the arc detection processing part 39. The AC current sensor 31 of the arc detecting apparatus 73 is provided at the circuit 24.

The optimizer 26 measures or calculates the current of the optimized power to the PCS 14 and acquires the DC current value which is the DC component of the current. Therefore, in this embodiment, the optimizer 26 inputs the DC current value of the power to the PCS 14 to the arc detection processing part 39 of the arc detecting apparatus 73. As a result, like the arc detecting apparatus 71 shown in FIG. 9, the occurrence of the arc in the circuit 24 can be quickly detected while the frequency of erroneous detection can be suppressed.

Like the PCS 14 shown in FIG. 8, the arc detecting apparatuses 72, 73 may be built in the optimizer 26.

### Modified Example

In the solar power system 1 shown in FIG. 10, three arc detection processing parts 39 are provided, but the three arc detection processing parts 39 may be adopted as one arc detection processing part 39. In this case, a switch may be provided for switching the signals from the three AC current sensors 31 and outputting the signals to the arc detection processing part 39. At this time, while it is difficult to constantly detect the presence or absence of the arc, the scale of the apparatus can be reduced.

### Implementation Example by Software

The control blocks (in particular, the CPU 35) of the arc detecting apparatuses 12 and 71 to 73 may be realized by a logic circuit (hardware) formed in an integrated circuit (IC chip), etc., or may be realized by software.

In the latter case, the arc detecting apparatuses 12 and 71 to 73 have a computer that executes instructions of a program, which is the software that realizes each function. The computer includes, for example, one or more processors, and includes a computer readable recording medium storing the program. In the computer, the objective of the disclosure is achieved by the processor reading the program from the recording medium and executing the program. As the processor, for example, a CPU can be used. As the recording medium, a tape, a disk, a card, a semiconductor memory, a programmable logic circuit, etc., in addition to a “non-transitory tangible medium” such as a read-only memory (ROM), can be used. Also, the computer may further include a random access memory (RAM), etc., for developing the program. Moreover, the program may be supplied to the computer via an arbitrary transmission medium (a communication network, a broadcast wave, etc.) capable of transmitting the program. It should be noted that an aspect of the disclosure can also be realized in the form of a data signal embedded in a carrier wave, where the program is realized through electronic transmission.

### ADDITIONAL NOTES

In the above embodiments, the presence or absence of the arc is determined from the power spectrum of the AC current signal, but the disclosure is not limited thereto. For example, as shown in FIG. 3(a), when the arc occurs, the amplitude of the AC current signal increases. Therefore, the presence or absence of the arc may be determined from the amplitude of the AC current signal.

Further, in the above embodiments, although the disclosure is applied to the solar power system, the disclosure is not limited thereto. The disclosure can be applied to any power system including a DC power source. Examples of the DC power source, in addition to the solar power apparatus, also include a fuel cell apparatus capable of obtaining electric energy (DC current power) by using hydrogen fuel through electrochemical reaction between hydrogen fuel and oxygen in the air, a storage battery for accumulating electric energy, a power storage apparatus such as a capacitor, etc.

According to the configuration and the method, the repeat number of the processing repeatedly performed to determine the presence or absence of the arc is set based on the DC current. For example, as the DC current increases, the repeat number may be decreased. When the DC current is high, the signal strength of the AC current is increased, and the possibility of erroneously determining noise other than the arc as the noise of the arc is decreased. On the other hand, when the repeat number decreases, the possibility of erroneous determination increases, but the occurrence of the arc can be detected quickly. Therefore, the occurrence of the arc can be quickly detected while the possibility of erroneous determination can be suppressed. That is, the occurrence of the arc can be quickly detected while the frequency of erroneously detecting the occurrence of the arc can be suppressed.

In the arc detecting apparatus, the repeat number may be the number of times that the arc determining part repeatedly acquires data of the AC current to determine the presence or absence of the arc.

In the arc determining apparatus, the arc determining part may make a temporary determination on the presence or absence of the arc based on the AC current, repeatedly make the temporary determination, and make a final determination on the presence or absence of the arc based on the number of times that the arc is temporarily determined as present. In this case, since the presence or absence of the arc is determined in two stages, the accuracy of the determination can be improved.

In the arc detecting apparatus, the repeat number may be the number of times that the arc determining part repeatedly makes the temporary determination.

In the arc detecting apparatus, the repeat number may be the number of times that the arc is temporarily determined as present through the arc determining part repeatedly making the temporary determination.

The arc detecting apparatus may further include a current measuring part which measures a current from the DC power source. In this case, the arc determining part can determine the presence or absence of the arc based on the AC current measured by the current measuring part. The repeat number setting part can set the repeat number based on the DC current measured by the current measuring part. It should be noted that the current measuring part may include an AC current sensor and a DC current sensor, or may include a current sensor capable of measuring both an AC current and a DC current.

Meanwhile, the DC power system often includes a converter apparatus including a converting part that converts a voltage of DC power from the DC power source and a control part that controls the converting part. The control part controls the converting part based on a current and a voltage before conversion and/or a current and a voltage after conversion.

Therefore, the DC power system may further include the converter apparatus of the above configuration, and the arc detecting apparatus may acquire a value of the DC current from the control part of the converter apparatus. In this case, it is not necessary to newly provide a measuring part for measuring the DC current. Examples of the converter apparatus include a PCS, an optimizer, etc. In addition, the arc detecting apparatus may be built in the converter apparatus.

According to an aspect of the disclosure, the occurrence of the arc can be quickly detected while the frequency of erroneous detection can be suppressed.

The disclosure is not limited to the above-described embodiments, various modifications are possible within the scope indicated in the claims, and embodiments obtained by appropriately combining technical means respectively disclosed in different embodiments are also included in the technical scope of the disclosure.

What is claimed is:

1. An arc detecting apparatus, comprising:
an arc determining part, which determines presence or absence of an arc based on an AC current from a DC power source that generates power or charges and discharges power; and
a repeat number setting part, which sets, based on a DC current from the DC power source, a repeat number of processing that the arc determining part repeatedly performs to determine the presence or absence of the arc.

2. The arc detecting apparatus as claimed in claim 1, wherein the repeat number is the number of times that the arc determining part repeatedly acquires data of the AC current to determine the presence or absence of the arc.

3. The arc detecting apparatus according to claim 1, wherein the arc determining part makes a temporary determination on the presence or absence of the arc based on the AC current, repeatedly makes the temporary determination, and makes a final determination on the presence or absence of the arc based on the number of times that the arc is temporarily determined as present.

4. The arc detecting apparatus according to claim 3, wherein the repeat number is the number of times that the arc determining part repeatedly makes the temporary determination.

5. The arc detecting apparatus according to claim 3, wherein the repeat number is the number of times that the arc is temporarily determined as present through the arc determining part repeatedly making the temporary determination.

6. The arc detecting apparatus according to claim 1, further comprising a current measuring part which measures a current from the DC power source.

7. A DC power system comprising:
a DC power source which generates power or charges or discharges power; and
the arc detecting apparatus according to claim 1.

8. The DC power system according to claim 7, further comprising:
a converter apparatus, which comprises:
a converting part which converts a voltage of DC power from the DC power source; and
a control part which controls the converting part,
wherein the arc detecting apparatus acquires a value of the DC current from the control part of the converter apparatus.

9. A non-transitory computer readable recording medium, recording a control program for causing a computer to serve as the arc detecting apparatus according to claim 1, the control program causing the computer to function as each of the parts.

10. A control method of an arc detecting apparatus, comprising:
an arc determining step of determining presence or absence of an arc based on an AC current from a DC power source that generates power or charges and discharges power; and
a repeat number setting step of setting a repeat number of processing repeatedly performed to determine the presence or absence of the arc in the arc determination step based on a DC current from the DC power source.

11. The arc detecting apparatus according to claim 2, wherein the arc determining part makes a temporary determination on the presence or absence of the arc based on the AC current, repeatedly makes the temporary determination, and makes a final determination on the presence or absence of the arc based on the number of times that the arc is temporarily determined as present.

12. The arc detecting apparatus according to claim 2, further comprising a current measuring part which measures a current from the DC power source.

13. The arc detecting apparatus according to claim 3, further comprising a current measuring part which measures a current from the DC power source.

14. The arc detecting apparatus according to claim 4, further comprising a current measuring part which measures a current from the DC power source.

15. The arc detecting apparatus according to claim 5, further comprising a current measuring part which measures a current from the DC power source.
